(19) United States
(12) Patent Application Publication
(10) Pub. No.: US 2020/0217825 A1
(43) Pub. Date: Jul. 9, 2020

(54) METHOD AND APPARATUS FOR LINEARIZING AND MITIGATING DENSITY DIFFERENCES ACROSS MULTIPLE CHROMATOGRAPHIC SYSTEMS

(71) Applicant: Waters Technologies Corporation, Milford, MA (US)

(72) Inventors: Joshua Shreve, Franklin, MA (US); Jason F. Hill, Milford, MA (US); Joseph D. Michienzi, Plainville, MA (US); Abhijit Tarafder, Blackstone, MA (US); Michael O. Fogwill, South Grafton, MA (US)

(73) Assignee: Waters Technologies Corporation, Milford, MA (US)

(21) Appl. No.: 16/334,118

(22) PCT Filed: Sep. 13, 2017
(86) PCT No.: PCT/US2017/051293

§ 371 Date: Mar. 18, 2019

Related U.S. Application Data
(60) Provisional application No. 62/396,739, filed on Sep. 19, 2016.

(51) Int. Cl. G01N 30/32; B01D 15/40; B01D 15/16; B01D 15/18; G01N 30/60; G01N 30/86

(52) U.S. Cl. CPC G01N 30/32; B01D 15/40; G01N 30/8658; B01D 15/1871; G01N 30/6065; B01D 15/163

(57) ABSTRACT

Methods for transferring a carbon dioxide based separation procedure from a first chromatographic system to a second one involve identifying an average column pressure for the separation in the first system is identified, determining a measured average column pressure for the separation in the second system, and comparing the measured average column pressure with the identified average column pressures. To more closely match the identified average column pressure, the methods involve: (a) altering a cross-sectional area of a column packed with media in the second system; and/or (b) adding makeup fluid along the length of the column in the second system. Columns with the characteristics used in the methods and second chromatographic systems are disclosed.

### CROSS-REFERENCE TO RELATED APPLICATIONS

This application is a National Stage Application of International Application No. PCT/US2017/051293, filed Sep. 13, 2017, which claims the benefit of and priority to U.S. Provisional Application No. 62/396,739, filed Sep. 19, 2016, and entitled “Method and Apparatus for Linearizing and Mitigating Density Differences Across Multiple Chromatographic Systems”. Each of the foregoing applications is incorporated herein by reference in its entirety.

### TECHNICAL FIELD

The present disclosure relates to supercritical fluid chromatography (SFC) and/or a carbon dioxide based chromatography system. More specifically, the present disclosure relates to methods and systems for controlling the density of the mobile phase in the region of interest of a chromatographic system.

### BACKGROUND OF THE INVENTION

Developing a successful chromatographic separation method usually requires extensive experimentation. Such method development often involves the evaluation and optimization of numerous variables. These variables may include the choice of chromatographic system (e.g., carbon dioxide based chromatography, SFC, high pressure liquid chromatography (HPLC), gas chromatography (GC)), the choice of mobile phase and mobile phase compositions, the choice of column chemistry and column dimensions, the choice of detector, etc. Once a successful chromatographic separation method has been developed, it often needs to be transferred and performed on different chromatographic systems. For example, separation on an analytical scale SFC system may need to be transferred and performed on a preparative scale SFC system. Similarly, a preparative scale SFC system may be modified thereby requiring the new separation method to be transferred and performed on a different preparative scale SFC system.

For liquid chromatography, the theory and understanding for transferring methods between different system or column configurations is generally well understood. Guidelines for transferring LC methods are straightforward and typically do not need additional optimization.

When employing a SFC and/or a carbon dioxide based chromatography system, however, effective separation method transfer between different chromatography systems requires special consideration. Chromatographic separations using a mobile phase comprising carbon dioxide that are transferred from one chromatographic system to another chromatographic system typically may need to be re-developed to achieve the same successful separation as achieved on the original chromatographic system.

In WO2014/201222 A1, researchers at Waters Technologies Corporation disclosed a methodology for scaling SFC and/or carbon dioxide based chromatography methods between different systems and/or column configurations. The methodology includes measuring an average mobile phase density from the density profile along the system during a first separation utilizing carbon dioxide as a mobile phase component and substantially duplicating the average density for a second separation to produce similar selectivity and retention factors. The researchers at Waters Technologies Corporation also disclosed that the average of the pressure profile may be used as a close approximation to duplicate average of the density profiles between separations.

In WO2015/023533 A1, researchers at Waters Technologies Corporation disclosed apparatus for regulating the average mobile phase density or pressure in a carbon dioxide based chromatographic system. The disclosed apparatus includes a controller, a set of pressure or density sensors and a set of instructions capable of determining the pressure drop across a column and adjusting at least one system component or parameter to achieve a predetermined average mobile phase density or pressure in the system. But since filing WO2015/023533 A1, researchers at Waters Technologies Corporation have discovered specific new ways to efficiently transfer a carbon dioxide-based separation procedure from a first chromatographic system to a second system.

### SUMMARY OF THE INVENTION

The present disclosure relates to methods and systems for efficiently transferring a carbon dioxide based separation procedure from a first chromatographic system to a second chromatographic system. The methods involve identifying an average column pressure for the carbon dioxide based separation in the first chromatographic system; determining a measured average column pressure for the carbon dioxide based separation in the second chromatographic system; and comparing the measured average column pressure for the carbon dioxide based separation in the second chromatographic system with the identified average column pressure for the carbon dioxide based separation in the first chromatographic system.

In some embodiments, determining a measured average column pressure for the carbon dioxide based separation in the second chromatographic system comprises calculating the measured average column pressure from a plurality of measurements proximate to the column in the second chromatographic system. In some embodiments, determining a measured average column pressure for the carbon dioxide based separation in the second chromatographic system comprises calculating the measured average column pressure from a plurality of measurements at an end of the column in the second chromatographic system.

In some embodiments, methods of the present invention involve altering a cross-sectional area of a column packed with media in the second chromatographic system along a length of the column to more closely match the identified average column pressure for the carbon dioxide based separation in the first chromatographic system. Altering the flow rate may comprise using a column in the second chromatography system comprising a column jacket comprising a thickness that increases along the length of the column and packed with media within the inner surface of the column jacket such that a cross-sectional area packed with media within the inner surface of the column jacket decreases along the length of the column. Altering the flow rate may comprise using a column in the second chromatography system comprising an insert comprising a thickness that increases along the length of the column, wherein an outer surface of the insert is proximate to the inner surface of the column jacket and wherein media is packed within an inner surface of the insert such that a cross-sectional area packed with media within the column jacket decreases along the length of the column. Altering the flow rate may comprise using a column in the second chromatography system comprising an insert comprising an annular cone, wherein media is packed between an inner surface of the column jacket and an outer surface of the insert such that a cross-sectional area within the column jacket comprising packed media decreases along the length of the column.

Some embodiments involve repeating the steps of determining a measured average column pressure for the carbon dioxide based separation in the second chromatographic system; comparing the measured average column pressure for the carbon dioxide based separation in the second chromatographic system with the identified average column pressure for the carbon dioxide based separation in the first chromatographic system; and altering a cross-sectional area of a column packed with media in the second chromatographic system along a length of the column to more closely match the identified average column pressure for the carbon dioxide based separation in the first chromatographic system. Some embodiments involve, iteratively or continually, repeatedly altering a cross-sectional area of a column packed with media in the second chromatographic system along a length of the column until the measured average column pressure for the carbon dioxide based separation in the second chromatographic system substantially matches the identified average column pressure for the carbon dioxide based separation in the first chromatographic system.

In some embodiments, the present invention comprises a column for a carbon dioxide based separation procedure in a chromatography system. In some embodiments, systems of the present invention include a column for a carbon dioxide based separation procedure in a chromatography system. The column includes a column jacket and media packed within the column jacket, wherein a cross-sectional area of media packed within the column jacket decreases along the length of the column. In some such columns, the column jacket comprises a thickness that increases along the length of the column such that a cross-sectional area of media packed within the column jacket decreases along the length of the column. In some such columns, the column comprises an insert having a thickness that increases along the length of the column, wherein an outer surface of the insert is proximate to the inner surface of the column jacket and wherein media is packed within an inner surface of the insert such that a cross-sectional area packed with media within the column jacket decreases along the length of the column. In some such columns, the column comprises an insert comprising an annular cone, wherein media is packed between an inner surface of the column jacket and an outer surface of the insert such that a cross-sectional area within the column jacket comprising packed media decreases along the length of the column.

In some embodiments, methods of the present invention involve adding makeup fluid along the length of a column in the second chromatography system to more closely match the identified average column pressure for the carbon dioxide based separation in the first chromatographic system. Adding makeup fluid along the length of a column in the second chromatography system may comprise allowing makeup fluid to flow, from a channel of makeup fluid within the column in the second chromatography system, through a porous material and into packed media along the length of the column. Adding makeup fluid along the length of a column in the second chromatography system may comprise allowing makeup fluid to flow, from a channel of makeup fluid within the column in the second chromatography system, through discrete apertures and into packed media along the length of the column. The channel of makeup fluid may be formed between an inner surface of the column jacket and an outer surface of a cylinder of porous material within the column. The channel of makeup fluid may be formed within an inner surface of the cylinder of porous material within the column.

Some embodiments involve repeating the steps of determining a measured average column pressure for the carbon dioxide based separation in the second chromatographic system; comparing the measured average column pressure for the carbon dioxide based separation in the second chromatographic system with the identified average column pressure for the carbon dioxide based separation in the first chromatographic system; and adding makeup fluid along the length of a column in the second chromatography system to more closely match the identified average column pressure for the carbon dioxide based separation in the first chromatographic system. Some embodiments involve, iteratively or continually, repeatedly adding makeup fluid along the length of a column in the second chromatography system until the measured average column pressure for the carbon dioxide based separation in the second chromatographic system substantially matches the identified average column pressure for the carbon dioxide based separation in the first chromatographic system.

In some embodiments, the present invention comprises a column for a carbon dioxide based separation procedure in a chromatography system. In some embodiments, systems of the present invention include a column for a carbon dioxide based separation procedure in a chromatography system. The column includes a column jacket, media packed within the column jacket, and an annular insert (e.g., a cylindrical annular insert) within the column jacket, wherein the annular insert allows makeup fluid to flow from a channel of makeup fluid within the column jacket, through the annular insert, and into the packed media along the length of the column. In some such columns, a porosity of the annular insert allows makeup fluid to flow, from a channel of makeup fluid within the column jacket, through the cylindrical annular insert and into the packed media along the length of the column. In some such columns, a plurality of discrete apertures allow makeup fluid to flow, from a channel of makeup fluid within the column in the second chromatography system, through the plurality of discrete apertures and into the packed media along the length of the column. In some such columns, the channel of makeup fluid is formed between an inner surface of the column jacket and an outer surface of the annular insert within the column. In some such columns, the channel of makeup fluid is formed within an inner surface of the annular insert within the column.

### BRIEF DESCRIPTION OF THE FIGURES

The foregoing and other features provided by embodiments of the present invention will be more fully understood from the following description when read together with the accompanying drawings.

FIG. 1 illustrates a chromatographic system in accordance with the prior art. FIG. 1B illustrates a column for a chromatographic system in accordance with the prior art.

FIG. 2 illustrates a method for efficiently transferring a carbon dioxide based separation from a first chromatographic system to a second chromatographic system in accordance with embodiments of the invention.

FIG. 3 illustrates a chromatographic system in accordance with embodiments of the invention.

FIG. 4 illustrates a column for a chromatographic system featuring a cross-sectional area that varies along its length in accordance with embodiments of the invention.

FIG. 5 illustrates a column for a chromatographic system featuring a cross-sectional area that varies along its length in accordance with embodiments of the invention.

FIG. 6 illustrates a column for a chromatographic system featuring a cross-sectional area that varies along its length in accordance with embodiments of the invention.

FIG. 7 illustrates a method for efficiently transferring a carbon dioxide based separation from a first chromatographic system to a second chromatographic system in accordance with embodiments of the invention.

FIG. 8 illustrates a column for a chromatographic system with features that enable fluid to be added along its length in accordance with embodiments of the invention.

FIG. 9 illustrates a column for a chromatographic system with features that enable fluid to be added along its length in accordance with embodiments of the invention.

FIG. 10 illustrates a column for a chromatographic system with features that enable fluid to be added along its length in accordance with embodiments of the invention.

### DETAILED DESCRIPTION

As used herein, the phrase “chromatographic system” refers to a combination of instruments or equipment, e.g., a pump, a column, a detector, and accompanying accessories that may be used to perform a separation to detect target analytes.

In some embodiments, the present disclosure relates to carbon dioxide based separation in a chromatographic system having a pump, a column located downstream of the pump, a detector located downstream of the column, a back pressure regulator located downstream of the detector, and a first sensor and a second sensor. In some such embodiments, the sensors may be pressure sensors for measuring mobile phase pressure in the system. Mobile phase pressure measurements may be used, along with measured or estimated mobile phase temperatures, to estimate the mobile phase density. The first sensor may be contained in or connected to an outlet of a pump, may be contained in or connected to an inlet of a column, or positioned anywhere in between. The second sensor may be contained in or connected to an inlet of a back pressure regulator, may be contained in or connected to an outlet of the column, or positioned anywhere in between. In some embodiments, the mobile phase density or pressure in the system may be at equilibrium when the first and second mobile phase density or pressure measurements are measured by the first and second sensors, or when the cross-sectional area of a column packed with media in the second system is altered or makeup fluid is added along the length of a column in a second system. In other embodiments, the mobile phase density or pressure in the system is not at equilibrium when the first and second mobile phase density or pressure measurements are measured by the first and second sensors, or when the cross-sectional area of a column packed with media in the second system is altered or makeup fluid is added along the length of a column in a second system.

In some embodiments, the present disclosure relates to carbon dioxide based separation in a chromatographic system having a controller, a first sensor and a second sensor both in signal communication with the controller, and a set of instructions utilized by the controller. The controller is capable of averaging the first and the second mobile phase pressure measurements to determine a measured average mobile phase pressure value. In some embodiments, the controller is capable of determining a measured average column pressure from the measured mobile phase pressure values. In some embodiments, the measured average mobile phase pressure value determined by the controller is a measured average column pressure or at least a close approximation thereof. In some such embodiments, the controller is capable of comparing the measured average column pressure with an identified average column pressure. In some such embodiments, the controller suggests altering a cross-sectional area of a column packed with media along the length of the column or adding makeup fluid along the length of the column to more closely match an identified average column pressure. In some such embodiments, the controller is capable of suggesting a column featuring a cross-sectional area that changes along the length of the column or a column that enable makeup fluid to be added along the length of the column to more closely match an identified average column pressure.

The present disclosure may be useful for transferring separations between analytical scale chromatographic systems, preparative scale chromatographic systems, and combinations thereof. For example, the present disclosure may be useful in transferring a separation from an analytical scale chromatographic system to a preparative scale chromatographic system, or a preparative scale chromatographic system to an analytical scale chromatographic system. The present disclosure may also be useful in transferring a separation from one analytical scale chromatographic system to another analytical scale chromatographic system, or from one preparative scale chromatographic system to another preparative scale chromatographic system. A list of chromatographic systems for which the present disclosure may be applicable include, but is not limited to, carbon dioxide-based chromatographic systems commercially available from Waters Technologies Corporation (Milford, Mass.) and branded as ACQUITY® UPC², Method Station SFC, Resolution SFC MS, Preparative SFC Instruments (e.g., Investigator SFC, Prep 100 SFC, SFC 80/200/350 Preparative Systems). Chromatographic systems for which the present disclosure may be applicable may comprise columns designed for use with a mobile phase including carbon dioxide. In some embodiments, columns designed for use with a carbon dioxide containing mobile phase are branded as Waters Technologies Corporation (Milford, Mass.) UPC² and/or SFC columns including both chiral and achiral stationary phases.

The distinction between different chromatographic systems, e.g., a first chromatographic system and a second chromatographic system, may include any change in the system configuration that results in a change in the overall operating average mobile phase density or average column pressure. For example, the distinction between different chromatographic systems may be the use of different instruments such as a carbon dioxide based analytical chromatographic system, for example a system commercially available from Waters Technologies Corporation (Milford, Mass.) and branded as an ACQUITY® UPC² system versus a carbon dioxide based preparative chromatography system, for example a system commercially available from Waters Technologies Corporation (Milford, Mass.) and branded as a Prep 100 SFC system. The distinction may also be a change in one or more components on the same instrument, e.g., a change in system configuration. For example, the distinction may be a change in column configuration, e.g. length, internal diameter or particle size, or a change in tubing, e.g., length or internal diameter, a change in a valve, e.g., the addition or removal of a valve, or the addition or removal of system components such as detectors, column ovens, etc.

Preferably, the present disclosure may be applied to any change or distinction, e.g. instrument, column particle size, column length, etc., between different chromatographic systems which results in greater than about a 10% change in overall operating average mobile phase density or average column pressure. More preferably, the present disclosure may be applied to any change or distinction which results in greater than about a 5% change in overall operating average mobile phase density or average column pressure. Even more preferably, the present disclosure may be applied to any change or distinction which results in greater than about a 1% change in overall operating average mobile phase density or average column pressure.

The present disclosure relates to efficiently transferring carbon dioxide based separations between systems. As used herein, the phrase “efficiently transferring” of a carbon dioxide based separation refers to the concept of transferring a carbon dioxide based separation, methodology, or method parameters between chromatographic systems while maintaining the chromatographic integrity of the separation, e.g., preserving retention factors and selectivity of at least one target analyte, preferably two or more target analytes. An efficiently transferred separation is one that substantially reproduces the chromatographic integrity of the separation obtained on the first chromatographic system on the second chromatographic system. For example, an efficiently transferred carbon dioxide based separation is one wherein the second carbon dioxide based separation performed on the second chromatographic system has a target analyte, or target analytes, having substantially the same retention factor (k′) or selectivity as the first carbon dioxide based separation performed on the first system.

As used herein, the term “retention factor” or “k′” refers to the ratio of time an analyte is retained in the stationary phase to the time it is retained in the mobile phase under either isocratic or gradient conditions. For an efficiently transferred carbon dioxide-based separation method, the difference in retention factor for any given target analyte between a first and a second separation should be minimized. Preferably, the difference in retention factor for a target analyte between a first and a second separation is less than about 10%. More preferably, the difference in retention factor for a target analyte between a first and a second separation is less than about 5%. Even more preferably, the difference in retention factor for a target analyte between a first and a second separation is less than about 1%.

For multiple target analytes, the difference in retention factor for each target analyte, respectively, between a first and a second separation should also be minimized. Multiple target analytes may include 2 or more target analytes, e.g., 2, 3, 4, 5, 6, 7, 8, 9, 10, etc. Preferably, all or a majority of the target analytes have substantially the same retention factor between the first and second separations. Because all analytes respond differently to system changes, not all of the target analytes may have substantially the same retention factor between the first and second separations. Preferably, the difference in retention factor for each multiple target analyte, respectively, between a first and a second separation is less than about 10%. More preferably, the difference in retention factor for each multiple target analyte, respectively, between a first and a second separation is less than about 5%. Even more preferably, the difference in retention factors for each multiple target analyte, respectively, between a first and a second separation is less than about 1%.

As used herein, the term “selectivity” or “separation factor” or “a” refers to the degree of separation of two analytes in a separation. For example, the separation factor for two analytes, A and B, is the ratio of their respective retention factors, provided A elutes before B, e.g., α=k′_{B}/k ′_{A}. The selectivity between two target analytes between a first and a second separation should be maintained. Preferably, the change in selectivity for two target analytes between a first and a second separation is less than about 10%. More preferably, the change in selectivity for two target analytes between a first and a second separation is less than about 5%. Even more preferably, the change in selectivity for two target analytes between a first and a second separation is less than about 1%.

As used herein, the phrases “carbon dioxide-based separation” and “carbon dioxide-based separation (procedure” refer to method parameters and/or settings used with a particular carbon dioxide based chromatographic system to control or effect a separation of target analytes. The mobile phase in a carbon dioxide-based separation includes at least, in part, carbon dioxide.

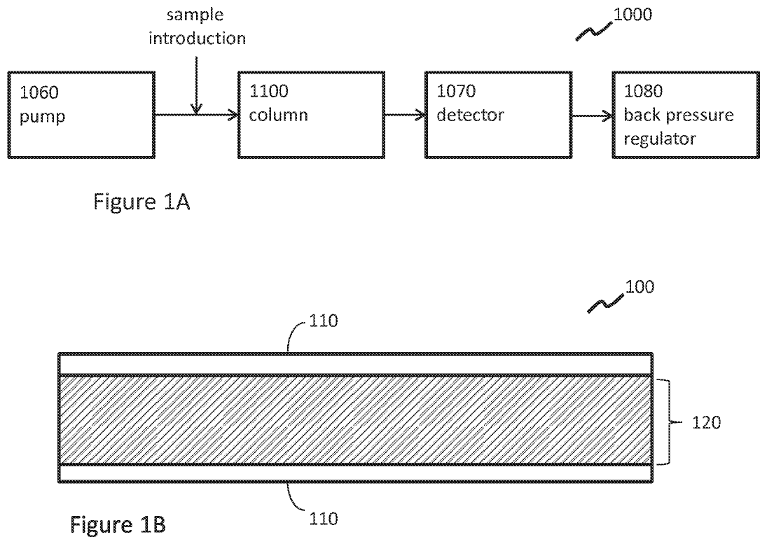

FIG. 1A illustrates a chromatographic system 1000 featuring a pump 1060, a column 1100, a detector 1070, and a back pressure regulator (BPR) 1080. A sample is introduced into chromatographic system 1000 of FIG. 1A between pump 1060 and column 1100. BPR 1080 has a set point. System 1000 experiences pressure dropping from the outlet of pump 1060 to the set point at the inlet of BPR 1080. Typically, the pressure drop will predominately occur between the inlet and the outlet of column 1100.

FIG. 1B illustrates a cross-section of column 100 in system 1000. Column 100 features a column jacket 110 and media 120 packed within column jacket 110. As FIG. 1B illustrates, the cross-section of the media 120 packed within column jacket 110 does not vary along the length of column 100. Although the cross-section of the media packed within column jacket 120 is consistent along the length of column 100, the pressure experienced will not be consistent along the length of column 100.

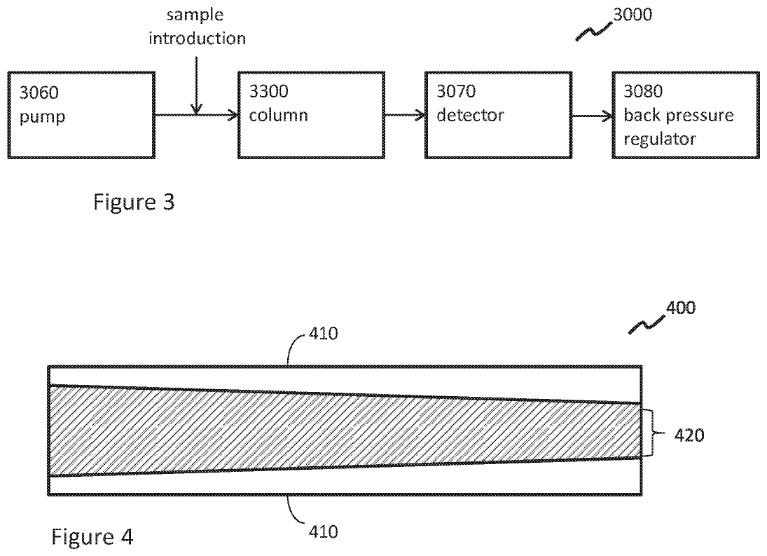

Similar to FIG. 1A, FIG. 3 illustrates a chromatographic system 3000 featuring pump 3060, column 3300, detector 3070, and BPR 3080. A sample is introduced into chromatographic system 3000 of FIG. 3 between pump 3060 and column 3300. System 3000 of FIG. 3 and system 1000 of FIG. 1A share a BPR set point. But chromatographic system 3000 of FIG. 3 differs from chromatographic system 1000 in a way that produces a change in the overall operating average mobile phase density or average column pressure.

The difference between system 1000 of FIG. 1A and system 3000 of FIG. 3 may produce a greater pressure drop across column 3300 than across column 1100. For example, a greater column particle diameter in column 1100 may produce a lesser pressure drop than a smaller particle diameter produces across column 3300. The systems will approximately share the same pressure at their respective BPRs, which share a BPR set point. Typically pressure drops predominately occur across the column of a chromatographic system. Thus, the average column pressure of the carbon dioxide based separation in the chromatographic system 3000 of FIG. 3 may be greater than the average column pressure of the carbon dioxide based separation in the chromatographic system 1000 of FIG. 1A. This is problematic for transfer of the separation from the first chromatographic system to the second chromatographic system. Due to the difference in average column pressure in the chromatographic systems, the average density of the mobile phase and, by extension, the retention characteristics of the analytes in the two separations, will be expected to differ.

Columns differences between chromatographic system are not limited to differences in particle diameter. Among other ways, columns may differ in length and internal diameter. Column stationary phases may differ in regard to chemistry, base particle, ligand, bonding density, endcapping, pore size, etc. Column manufacturers typically produce columns having the same stationary phase, e.g., same chemistry, same base particle, same ligand, same bonding density, same endcapping and same pore size, in several different particle size and column dimension configurations. In one embodiment, the two different separation systems have a first and a second respective column, wherein the first and second columns have similar stationary phases. The similar stationary phases may have, at least, same chemistry, same base particle, same ligand, same bonding density, same endcapping or same pore size. The present invention is applicable where the columns in two different chromatographic systems have the same stationary phase.

Due to the compressible nature of the carbon dioxide based mobile phase at or near supercritical conditions, the mobile phase density must be managed from the sample introduction to detection. More specifically, the average density of the mobile phase across the column must be conserved in order to match retention characteristics of the analytes.

As disclosed in the prior art, the average column pressure of the mobile phase can be adjusted by adjusting the set point of the BPR. For example, the set point of the BPR 3080 may be selected to address the pressure difference that may be caused by differences between the column particle diameters of column 1100 and column 3300. In particular, the set point of BPR 3080 may be decreased in FIG. 3 to produce a lesser average pressure in column 3300 of system 3000. Thus, despite a particle diameter of the column 3300 of FIG. 3 smaller than that of column 1100 of FIG. 1A, the average column pressure of FIG. 3 may be substantially the same as the average column pressure of FIG. 1A. Thus, the retention characteristics of analytes in the separation of FIG. 1A would be expected to substantially match those in the separation of FIG. 3.

The inventors of the present disclosure recognized that, using average pressure as a close approximation for average density, the effect of mobile phase density on solubility and analyte retention can be normalized by substantially duplicating the average column pressure from a separation method in a first chromatographic system in a separation method in a second chromatographic system. The inventors were aware that settings related to the back pressure regulator (BPR) may be changed to substantially match an average column pressure in another chromatographic system. But the inventors further recognized that an average column pressure may be achieved in different SFC and/or a carbon dioxide based chromatographic systems without changing the settings related to BPR. The inventors further recognized that an average column pressure may be achieved in different SFC and/or a carbon dioxide based chromatographic systems without solely relying on changing the settings related to post-detector BPR.

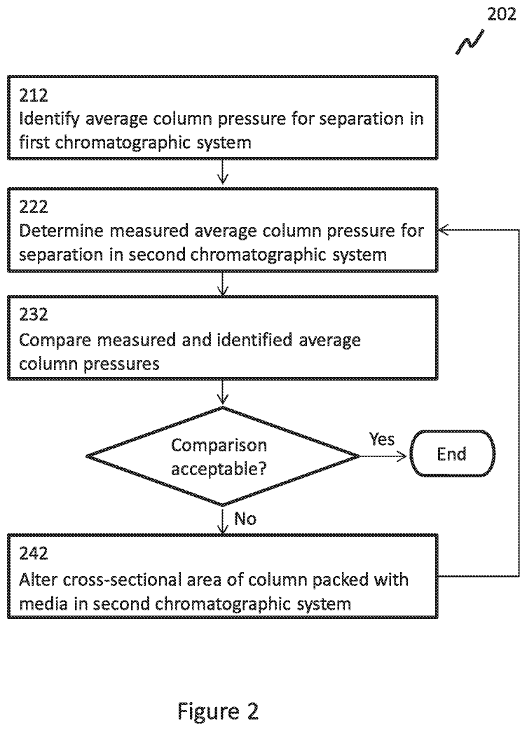

The inventors recognized that cross-sectional area of a column packed with media can be altered along the length of the column to adjust the average column pressure in a chromatographic system. FIG. 2 illustrates a method 202 for efficiently transferring a carbon dioxide based separation procedure from a first chromatographic systems to a second chromatographic system in accordance with embodiments of the invention. In step 212 of FIG. 2A, an average column pressure for a separation in a first chromatographic system is identified. The identified average column pressure will be that for successful carbon dioxide based separation on the first chromatographic system. This average column pressure may be known and therefore readily available for identification. For example, where its separation is successful, the average column pressure P_{S1} for a first chromatographic system 1000 of FIG. 1A may be identified by mere reference to the know value. To the extent that the average column pressure for a successful separation in the first chromatographic system is not known, the column pressure in the first system may be measured and its average may be determined in step 212.

Step 222 of FIG. 2 involves a second chromatographic system. The second chromatographic system in step 222 differs from the first chromatographic system in step 212. Chromatographic system 3000 of FIG. 3 may be the second chromatographic system of step 222. For example, chromatographic system 3000 and chromatographic system 1000 may differ in the particle diameter in their respective columns. The particle diameter of column 1100 may be greater than that of column 3300 of FIG. 3. As noted above, the difference in the column particle diameters results in a change in the overall operating average mobile phase density or average column pressure.

In step 222 of FIG. 2, a measured average column pressure for a separation in a second chromatographic system is determined. Step 222 involves averaging a plurality of measurements. With respect to system 3000 of FIG. 3, measurements may be taken at the inlet and outlet of column 3300. Alternatively with respect to system 3000 of FIG. 3, measurements may be taken at the outlet of pump 3060 and at the inlet of BPR 3080. Still alternatively with respect to system 3000 of FIG. 3, measurements may be taken between the outlet of pump 3060 and the inlet of column 3300 and between the outlet of pump 3300 and the inlet of BPR 3080. Any of the foregoing measurements can be used to determine the average column pressure. Particularly if the column pressure of the first chromatographic system is similarly measured, a more remote measurement of column pressure in the second chromatographic system should be acceptably accurate and precise.

In step 232 of FIG. 2, the measured average column pressure for carbon dioxide based separation in a second chromatographic system is compared to the identified average column pressure for carbon dioxide based separation in the first chromatographic system. For example, due to a greater particle diameter in column 1100, the average column pressure of the carbon dioxide based separation in the chromatographic system 1000 of FIG. 1A may be less than the average column pressure in system 3000 of FIG. 3. In a typical first comparison, the average column pressures do not substantially match and the difference is not be acceptable. For the purpose of this disclosure, we presume that the difference between the average column pressures of system 3000 and system 1000 is not acceptable.

In step 242 of FIG. 2, the cross-sectional area packed with media is varied along a length of the column in the second chromatographic system to more closely match the identified average column pressure for carbon dioxide based separation in the first chromatographic system. As guidance for altering the cross-sectional area of the packed media along the length of the column, the inventors recognized that altering the cross-sectional area along the length of the column will change the mobile phase pressure profile between the inlet and the inlet of the column. Decreasing the cross-sectional area packed with media within the column jacket along the length of the column in the direction of flow of the mobile phase will increase the pressure drop along the length of the column. On the other hand, increasing the cross-sectional area packed with media within the column jacket along the length of the column in the direction of flow of the mobile phase will decrease the pressure drop along the length of the column. In providing the foregoing guidance, the inventors presume that the flow rate of the mobile phase is maintained along the length of the column. The inventors recognized that it is useful to recognize that the BPR set point represents the lower limit of the column pressure. The inventors further recognized that the cross-sectional area packed with media within the column jacket will predominately affect the pressure between the inlet and the outlet of the column. Armed with this understanding, the cross-sectional area packed with media within the column jacket along the length of the column in the second chromatographic system can be readily altered to more closely match the identified average column pressure for carbon dioxide based separation in the first chromatographic system.

Step 242 of method 202 may comprise selecting a different column for the second chromatographic system. FIGS. 4, 5, and 6 each illustrate a column for a chromatographic system featuring a cross-sectional area packed with media that varies along its length in accordance with embodiments of the invention. Any of the columns described with respect to FIGS. 4, 5, and 6 may be used in step 242 of method 202 in accordance with embodiments of the invention.

FIG. 4 illustrates a cross-section of column 400 for a chromatographic system featuring a column jacket 410 having a thickness that varies along its length. As illustrated in FIG. 4, the thickness of jacket 410 varies uniformly and continuously from one end of the jacket to the other. Nonetheless, the thickness of jacket 410 need not vary uniformly from one end of the jacket to the other. For example, the thickness may vary incrementally from one thickness to another. Similarly, the thickness of jacket 410 need not vary continuously from one end of the jacket to the other. For example, the thickness may vary for only a portion of the length of the jacket. The interior of column jacket 410 is packed with media 420. Due to the thickness variation of jacket 410, the cross-sectional area packed with media 420 varies along the length of column 400.

Additionally or alternatively, the diameter of a column jacket may vary along the length of the column such that the cross-sectional area within the column jacket packed with media varies along the length of column. The diameter of the jacket may uniformly and continuously vary from one end of the jacket to the other. Nonetheless, the diameter of the jacket need not vary uniformly from one end of the jacket to the other. For example, the diameter may vary incrementally from one thickness to another. Similarly, the diameter of the jacket need not vary continuously from one end of the jacket to the other. For example, the diameter may vary for only a portion of the length of the jacket. Due to the diameter variation of the jacket, the cross-sectional area packed with media varies along the length of the column.

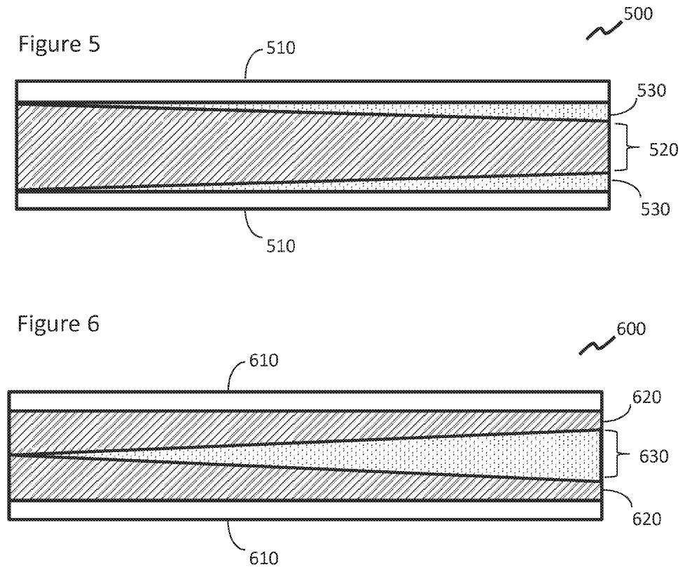

Step 242 of method 202 may comprise modifying the column in the second chromatographic system, such as by adding an insert. FIGS. 5 and 6 each illustrate a column for a chromatographic system featuring an insert within the column jacket that causes a cross-sectional area packed with media to vary along the length of the column in accordance with embodiments of the invention.

FIG. 5 illustrates a cross-section of a column 500 for a chromatographic system featuring a column jacket 510, an insert 530, and media 520 packed within the insert. Although the thickness of column jacket 510 may not vary, in FIG. 5, the thickness of insert 530 does vary along the length of the column. As illustrated in FIG. 5, the thickness of insert 530 varies uniformly and continuously from one end of the insert to the other. Nonetheless, the thickness of insert 530 need not vary uniformly from one end of the jacket to the other. For example, the thickness may vary incrementally from one thickness to another. Similarly, the thickness of insert 530 need not vary continuously from one end of the jacket to the other. For example, the thickness may vary for only a portion of the length of the jacket. Insert 530 is placed along the interior surface of column jacket 510 as a liner for column jacket 510. The interior of insert/liner 530 is packed with media 520. Due to the thickness variation of insert 530, the cross-sectional area packed with media 520 varies along the length of column 500.

FIG. 6 illustrates a cross-section of a column 600 for a chromatographic system featuring a column jacket 610, an insert 630, and media 620 packed within the insert. Although the thickness of column jacket 610 may not vary, in FIG. 6, the thickness of insert 630 does vary along the length of the column. As illustrated in FIG. 6, the thickness of insert 630 varies uniformly and continuously from one end of the insert to the other. Nonetheless, the thickness of insert 630 need not vary uniformly from one end of the jacket to the other. For example, the thickness may vary incrementally from one thickness to another. Similarly, the thickness of insert 630 need not vary continuously from one end of the jacket to the other. For example, the thickness may vary for only a portion of the length of the jacket. Insert 630 is placed in the center of column 600. The space between the inner surface of jacket 610 and insert 630 is packed with media 620. Due to the thickness variation of insert 630, the cross-sectional area packed with media 620 varies along the length of column 600.

In step 242 of FIG. 2, the cross-sectional area packed with media within the column jacket is altered along the length of column 3300 of system 3000 to address the difference between the average column pressure P_{S1} of the carbon dioxide based separation in the chromatographic system 1000 of FIG. 1A and the average column pressure P_{S2} in system 3000 of FIG. 3. Again, the difference in average column pressure may have been caused by the difference in the column particle diameters. In this example, a smaller column particle diameter produces a greater pressure drop across column 3300 than a larger particle diameter produces across column 1100. Accordingly, at a constant mobile phase mass flow rate, the cross-sectional area packed with media within the column jacket is decreased along the length of column 3300 to increase the pressure drop across column 3300. Where the set points of BPR 3080 of system 3000 and BPR 1080 of system 1000 establish the same lower limit for the pressure at the outlets of column 3300 and column 1100, respectively, lowering the pressure drop across column 3300 should lower the average column pressure P_{S2} for separation in of system 3000 of FIG. 3 to more closely match the identified average column pressure P_{S1} for the carbon dioxide based separation in the first chromatographic system 1000.

As illustrated in FIG. 2, method 202 may further include determining a new measured average column pressure in step 222 after altering the cross-sectional area packed with media along the length of column in step 242. Decreasing the cross-sectional area packed with media in the direction of mobile phase flow along the length of column, while otherwise keeping system 3000 the same, should decrease the pressure drop across column 3300 and lower the average column pressure for the carbon dioxide based separation in the chromatographic system 3000. According, the new measured average column pressure for system 3000 should be lower.

As illustrated in FIG. 2, method 202 may further include comparing the new measured average column pressure to the identified average column pressure in step 232 after altering the cross-sectional area packed with media along the length of column in step 242. In the illustrative example, the average column pressure P_{FR2} produced by the new cross-sectional area packed with media along the length of column in system 3000 of FIG. 3 is closer to the identified average column pressure P_{S1} than the average column pressure P_{S2} initially produced by system 3000. Accordingly, the cross-sectional area packed with media along the length of column can be altered to more closely match a target average column pressure in a chromatography system.

Despite the fact that the particle diameter of the column 3300 of FIG. 3 is less than that of column 1100 of FIG. 1A, the average column pressure P_{S2} produced by the new cross-sectional area packed with media along the length of column 3300 in system 3000 of FIG. 3 substantially matches the average column pressure P_{S1} of FIG. 1A. Accordingly, by altering the cross-sectional area packed with media along the length of column, even without adjusting the BPR set point, the average column pressure of a first chromatographic system can be substantially matched by the average column pressure in the second chromatographic system. Thus, the retention characteristics of analytes in the separation of FIG. 1A would be expected to substantially match those in the separation of FIG. 3.

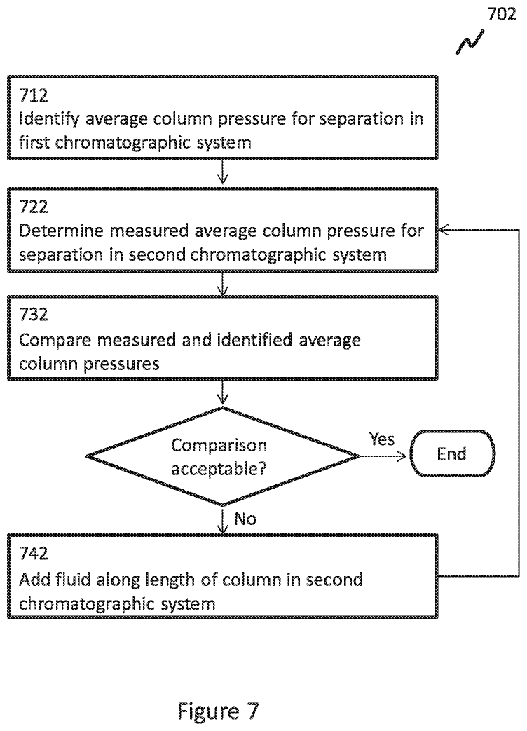

The inventors also recognized that makeup fluid may be added along the length of a column in a second chromatography system to more closely match an identified average column pressure for carbon dioxide based separation in a first chromatographic system. FIG. 7 illustrates a method 702 for efficiently transferring a carbon dioxide based separation procedure from a first chromatographic systems to a second chromatographic system in accordance with embodiments of the invention. In step 712 of FIG. 7, an average column pressure for a separation in a first chromatographic system is identified. Step 712 is similar to step 212, and the variations described above with respect to FIG. 2 apply. In this example, the average column pressure P_{S1} for the successful separation in first chromatographic system 1000 of FIG. 1A is again identified by mere reference to the know value.

Like step 222 of FIG. 2, step 722 of FIG. 7 involves a second chromatographic system. The second chromatographic system in step 722 differs from the first chromatographic system in step 712. Chromatographic system 3000 of FIG. 3 may be the second chromatographic system of step 722. For example, chromatographic system 3000 and chromatographic system 1000 may differ in the particle diameter in their respective columns. The particle diameter of column 1100 may be greater than that of column 3300 of FIG. 3. As noted above, the difference in the column particle diameters results in a change in the overall operating average mobile phase density of average column pressure.

In step 722 of FIG. 7, a measured average column pressure for a separation in a second chromatographic system is determined. Step 722 is similar to step 222, and the variations described above with respect to FIG. 2 apply.

In step 732 of FIG. 7, the measured average column pressure for carbon dioxide based separation in a second chromatographic system is compared to the identified average column pressure for carbon dioxide based separation in the first chromatographic system. For example, due to a greater particle diameter in column 1100, the average column pressure of the carbon dioxide based separation in the chromatographic system 1000 of FIG. 1A may be less than the average column pressure in system 3000 of FIG. 3. In other words, the average column pressure for separation in system 3000 is greater than the average column pressure for separation in system 1000 of FIG. 1A. In a typical first comparison, the average column pressures do not substantially match and the difference is not acceptable. For the purpose of this disclosure, we presume that the difference between the average column pressures of system 3000 and system 1000 is not acceptable.

In step 742 of FIG. 7, makeup fluid is added along a length of the column in the second chromatographic system to more closely match the identified average column pressure for carbon dioxide based separation in the first chromatographic system. As guidance, the inventors recognized that adding makeup fluid along the length of the column will increase the mobile phase pressure drop between the inlet and the outlet of the column. The inventors recognized that the BPR set point represents the lower limit of the column pressure. The inventors further recognized that, when all other elements and separation conditions in the second chromatographic system remain the same, adding makeup fluid along the length of the column will increase the pressure drop along the column. Armed with this understanding, adding makeup fluid along the length of the column in the second chromatographic system can be readily done to more closely match the identified average column pressure for carbon dioxide based separation in the first chromatographic system.

The makeup fluid added in step 742 is preferably the same composition as that of the mobile phase. Nonetheless, the inventors recognized that the makeup fluid could have a different composition that was miscible with that of the mobile phase. The inventors similarly recognized that the makeup fluid could have a composition that was immiscible with that of the mobile phase to block portions of the column. The inventors further recognized that the composition of the makeup fluid could be altered over time to substantially match the composition of the mobile phase when the mobile phase is undergoing a composition program gradient separation. Alternatively, the inventors further recognized that a gradient in the makeup fluid could be introduced such that the composition of the makeup fluid does not substantially match the composition of the mobile phase when the mobile phase is undergoing a composition program gradient separation.

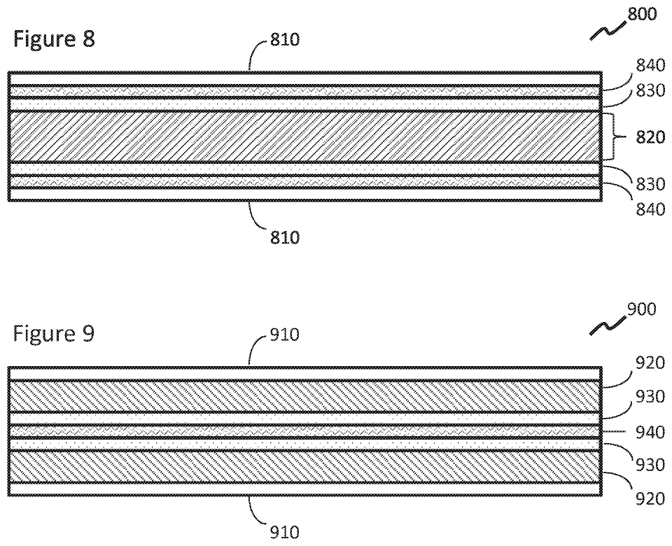

Step 742 of method 702 may comprise selecting a different column for the second chromatographic system. Step 742 of method 702 may comprise modifying a column in the second chromatographic system, such as by adding an insert to the column. FIGS. 8, 9, and 10 each illustrate a column for a chromatographic system with features that enable makeup fluid to be added along its length in accordance with embodiments of the invention. Any of the columns described with respect to FIGS. 8, 9, and 10 may be used in step 742 of method 702 in accordance with embodiments of the invention.

FIG. 8 illustrates a cross-section of column 800 for a chromatographic system featuring a column jacket 810 and a porous insert 830 centered in the column. As illustrated in FIG. 8, insert 830 forms a channel 840 between the inner surface of column jacket 810 and the outer surface of insert 830 along which mobile phase fluid may flow. The inventors recognized that channel 840 should be sized to avoid a pressure drop along its length. The size of channel 840 may be varied by varying the inner diameter of the column jacket and/or the outer diameter of insert 830. As further illustrated in FIG. 8, the interior of insert 830 is packed with media 820. The size of the space packed with media may be varied by varying the inner diameter of insert 830.

As illustrated in FIG. 8, insert 830 features uniformity in thickness and diameter. But the thickness of insert 830 need not be uniform from one end of column 800 to the other. For example, the thickness of insert 830 may vary continuously or incrementally from one thickness to another along the length of column 800. Similarly, the diameter (or other dimension of cross-sectional shape) of insert 830 need not be uniform from one end of column 800 to the other. For example, the diameter of insert 830 may vary continuously or incrementally from one diameter to another along the length of column 800. Further, the porosity of insert 830 need not be uniform from one end of column 800 to the other. For example, the porosity of insert 830 may vary continuously or incrementally from one porosity to another along the length of column 800.

In operation of a second chromatographic system including column 800, mobile phase fluid may be introduced into channel 840 axially and/or radially. For example, mobile phase fluid may be introduced through a single port that allows it to flow axially into channel 840. To the extent mobile phase fluid is introduced to channel 840 radially, it may be introduced only at one or more portions of the length of column 800. Similarly, fluid may be introduced into packed media 820 axially and/or radially through porous insert 830 from channel 840. The mobile phase fluid that has been introduced flows through packed media 820 and also more-freely, through channel 840.

As the pressure drops along portion of column 800 packed with media 820, some mobile phase fluid from channel 840 migrates through the pores in porous insert 830 into the packed stationary phase media 820. The amount of fluid that migrates through porous insert 830 depends on the porosity, thickness, and diameter of insert 830. The amount of fluid that migrates through porous insert 830 further depends on the pressure differential between channel 840 and media 820. The amount of fluid that migrates through porous insert 830 further depends on the pressure and temperature of the mobile phase fluid in channel 840. The fluid that migrates into the stationary phase media 820 in column 800 may be called makeup fluid and have features described above with respect to step 742. And its migration would decrease the pressure drop along column 800.

As further explained below, column 800 may alternatively feature an insert with discrete apertures. Like porous insert 830 illustrated in FIG. 8, an insert with discrete apertures would form a channel 840 between the inner surface of column jacket 810 and the outer surface of the insert along which mobile phase fluid may flow. Like porous insert 830, an insert with discrete apertures need not be uniform in diameter or thickness from one end of column 800 to the other. Similar to porous insert 830, the apertures in an insert with discrete apertures need not be uniform from one end of column 800 to the other. For example, the apertures of an insert with discrete apertures may vary in size continuously or incrementally from one diameter to another along the length of column 800. Additionally, the spacing between apertures of an insert with discrete apertures may vary continuously or incrementally from one spacing to another along the length of column 800. As further illustrated in FIG. 8, the interior of insert 830 is packed with media 820.

FIG. 9 illustrates a cross-section of column 900 for a chromatographic system featuring a column jacket 910 and a porous insert 930 centered in the column. As illustrated in FIG. 9, insert 930 forms a channel 940 within the inner surface of insert 930 along which mobile phase fluid may flow. The size of channel 940 may be varied by varying the inner diameter of insert 930. As further illustrated in FIG. 9, the space between the inner surface of column jacket 910 and the outer surface of insert 930 is packed with media 920. The size of the space packed with media may be varied by varying either the inner diameter of the column jacket and/or the outer diameter of insert 930.

As illustrated in FIG. 9, insert 930 features uniformity in thickness and diameter. But the thickness of insert 930 need not be uniform from one end of column 900 to the other. For example, the thickness of insert 930 may vary continuously or incrementally from one thickness to another along the length of column 900. Similarly, the diameter of insert 930 need not be uniform from one end of column 900 to the other. For example, the diameter of insert 930 may vary continuously or incrementally from one diameter to another along the length of column 900. Additionally, the porosity of insert 930 need not be uniform from one end of column 900 to the other. For example, the porosity of insert 930 may vary continuously or incrementally from one porosity to another along the length of column 900.

In operation of a second chromatographic system including column 900, mobile phase fluid may be introduced into packed media 920 axially and/or radially through the porous insert 930 from channel 940. For example, mobile phase fluid may be introduced through a single port that allows it to flow axially into packed media 920. To the extent mobile phase fluid is introduced to packed media 920 radially, it may be introduced only at one or more portions of the length of column 900. The mobile phase fluid that has been introduced flows through packed media 920 and also more-freely, through channel 940.

As the pressure drops along portion of column 900 packed with media 920, some mobile phase fluid from channel 940 migrates through the pores in porous insert 930 into packed stationary phase media 920. The amount of fluid that migrates through the pores in porous insert 930 depends on the porosity, thickness, and diameter of insert 930. The amount of fluid that migrates through porous insert 930 further depends on the pressure differential between channel 940 and media 920. The amount of fluid that migrates through porous insert 930 further depends on the pressure and temperature of the mobile phase fluid in channel 940. The fluid that migrates into the stationary phase media 920 in column 900 may be called makeup fluid and have features described above with respect to step 742. And its migration would decrease the pressure drop along column 900.

As further explained below, column 900 may alternatively feature an insert with discrete apertures. Like porous insert 930 illustrated in FIG. 9, an insert with discrete apertures would form a channel 940 within the inner surface of insert 930 along which mobile phase fluid may flow Like porous insert 930, an insert with discrete apertures need not be uniform in diameter or thickness from one end of column 900 to the other. Similar to porous insert 930, the apertures in an insert with discrete apertures need not be uniform from one end of column 900 to the other. For example, the apertures of an insert with discrete apertures may vary in size continuously or incrementally from one diameter to another along the length of column 900. Additionally, the spacing between apertures of an insert with discrete apertures may vary continuously or incrementally from one spacing to another along the length of column 900. As further illustrated in FIG. 9, the space between the inner surface of column jacket 910 and the outer surface of insert 930 is packed with media 920.

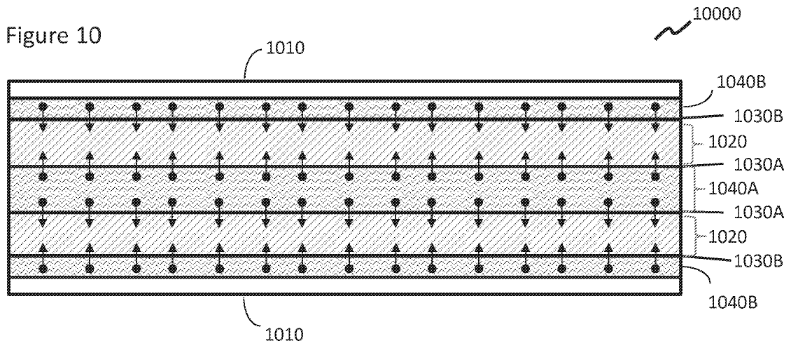

FIG. 10 illustrates a cross-section of a column 10000 for a chromatographic system featuring a column jacket 1010 and two inserts 1030A, 1030B centered within the column. The column jacket 1010 and two inserts 1030A, 1030B form two channels 1040A, 1040B along which mobile phase fluid may flow. Inner channel 1040A is formed within the inner surface of the inner insert 1030A. Outer channel 1040B is formed between the outer surface of outer insert 1030B and the inner surface of column jacket 1010. Media 1020 is packed between the inner surface of outer insert 1030B and the outer surface of inner insert 1030A. As illustrated in FIG. 10, inserts 1030A, 1030B both feature discrete apertures that allow mobile phase fluid to flow from a channel 1040A or 1040B into packed media 1020.

As illustrated in FIG. 10, each of the two inserts 1030A, 1030B is uniform in diameter and thickness. But neither insert 1030A or 1030B must be uniform in diameter or thickness from one end of column 10000 to the other. The apertures in each of the two inserts 1030A, 1030B also need not be uniform from one end of column 900 to the other. For example, the apertures of either or both inserts may vary in size continuously or incrementally from one diameter to another along the length of column 10000. Similarly, the spacing between apertures of either or both inserts may vary continuously or incrementally from one spacing to another along the length of column 10000. Additionally, the spacing between the two inserts 1030A, 1030B and between the outer surface of outer insert 1030B and the inner surface of column jacket 1010 may vary. Accordingly, the size of the channels and the space packed with media 1020 may be varied. The inventors recognized that channel 1040B should be sized to avoid a pressure drop along its length.

In operation of a second chromatographic system including column 10000, mobile phase fluid flows through packed media 1020 and also more-freely, through inner channel 1040A and outer channel 1040B. As the pressure drops along the packed media 1020 portion of column 10000, some mobile phase fluid from inner channel 1040A and/or outer channel 1040B migrates through the apertures in inserts 1030A, 1030B into the packed stationary phase media 1020. As illustrated by the arrows in FIG. 10, mobile phase fluid may flow into the packed media 1020 both from inner channel 1040A through apertures in inner insert 1030A and from outer channel 1040B through apertures in outer insert 1030B.

The amount of fluid that migrates through apertures in inserts 1030A, 1030B depends on the size and spacing of the apertures. The amount of fluid that migrates through apertures in inserts 1030A, 1030B further depends on the pressure differential between the packed media 1020 and inner channel 1040A or outer channel 1040B. The amount of fluid that migrates through apertures in inserts 1030A, 1030B further depends on the pressure and temperature of the mobile phase fluid in channels 1040A, 1040B. The fluid that migrates into the stationary phase media 820 in column 800 may be called makeup fluid and have features described above with respect to step 742. And its migration decreases the pressure drop within the packed media portion 1020 along column 10000.

In step 742 of FIG. 7, makeup fluid is added along the length of column 3300 of system 3000 to address the difference between the average column pressure P_{S1} of the carbon dioxide based separation in the chromatographic system 1000 of FIG. 1A and the average column pressure P_{S2} in system 3000 of FIG. 3. Again, the difference in average column pressure may have been caused by the difference in the column particle diameters. In this example, a smaller column particle diameter produces a greater pressure drop across column 3300 than a larger particle diameter produces across column 1100. Accordingly, the makeup fluid is added along the length of column 3300 to decrease the pressure drop across the packed media portion of column 3300. Where the set points of BPR 3080 of system 3000 and BPR 1080 of system 1000 establish the same lower limit for the pressure at the outlets of column 3300 and column 1100, respectively, lowering the pressure drop across column 3300 should lower the average column pressure P_{S2} for separation in of system 3000 of FIG. 3 to more closely match the identified average column pressure P_{S1} for the carbon dioxide based separation in the first chromatographic system 1000.

As illustrated in FIG. 7, method 702 may further include determining a new measured average column pressure in step 722 after adding the makeup fluid along the length of column in step 742. Adding makeup fluid to the packed media portion of column 3300 downstream of it inlet, while otherwise keeping system 3000 the same, should decrease the pressure drop across the packed media portion of column 3300 and lower the average column pressure for the carbon dioxide based separation in the chromatographic system 3000. According, the new measured average column pressure for system 3000 should be lower.

As illustrated in FIG. 7, method 702 may further include comparing the new measured average column pressure to the identified average column pressure in step 732 after adding makeup fluid along the length of column in step 742. In the illustrative example, the average column pressure P_{S2} produced by the new cross-sectional area packed with media along the length of column in system 3000 of FIG. 3 is closer to the identified average column pressure P_{S1} than the average column pressure P_{S2} initially produced by system 3000. Accordingly, makeup fluid can be added along the length of the column to more closely match a target average column pressure in a chromatography system.

Despite the fact that the particle diameter of the column 3300 of FIG. 3 is less than that of column 1100 of FIG. 1A, the average column pressure P_{S2} produced by the new cross-sectional area packed with media along the length of column 3300 in system 3000 of FIG. 3 substantially matches the average column pressure P_{S1} of FIG. 1A. Accordingly, by adding makeup fluid along the length of column, even without adjusting the BPR set point, the average column pressure of a first chromatographic system can be substantially matched by the average column pressure in the second chromatographic system. Thus, the retention characteristics of analytes in the separation of FIG. 1A would be expected to substantially match those in the separation of FIG. 3.

The inventors further recognized that the disclosed methods for efficiently transferring a carbon dioxide based separation from a first chromatographic system to a second chromatographic system may be combined. For example, if the comparison of the measured average column pressure for carbon dioxide based separation in the second chromatographic system with the identified average column pressure for carbon dioxide based separation in the first chromatographic system (step 232/step 732) indicates that the difference is not acceptable, step 242 of method 202 and step 742 of method 702 may be combined. Accordingly, the cross-sectional area of the column packed with media may be altered and makeup fluid may be added along the length of the column in the second chromatographic system. A combined step may include selecting a new column for the second chromatographic system or modifying the column in the second chromatographic system. For example, the combined step may include modifying a column such as columns 400, 500, or 600 by adding a porous insert such as described with respect to FIGS. 8 and 9 or an insert featuring discrete apertures such as described with FIG. 10. The insert may be used to enable the addition of makeup fluid by forming a channel that enables fluid to flow through the insert into the packed media. An insert may substantially follow the cross-sectional area of the packed media to form a channel. For example, an insert may create a channel with a substantially uniform width by featuring a substantially uniform offset from the inner surface of column jacket 410. Alternatively, an insert may form a channel with a width that substantially varies.

What is claimed is:

1. A method for efficiently transferring a carbon dioxide based separation procedure from a first chromatographic system to a second chromatographic system, the method comprising:
(a) identifying an average column pressure for the carbon dioxide based separation in the first chromatographic system;
(b) determining a measured average column pressure for the carbon dioxide based separation in the second chromatographic system; and
(c) comparing the measured average column pressure for the carbon dioxide based separation in the second chromatographic system with the identified average column pressure for the carbon dioxide based separation in the first chromatographic system; and
(d) altering a cross-sectional area of a column packed with media in the second chromatography system along a length of the column to more closely match the identified average column pressure for the carbon dioxide based separation in the first chromatographic system.

2. The method of claim 1 wherein the step of altering a cross-sectional area of a column packed with media in the second chromatography system along a length of the column comprises using a column in the second chromatography system comprising a column jacket comprising a thickness that increases along the length of the column and packed with media within the inner surface of the column jacket such that a cross-sectional area packed with media within the inner surface of the column jacket decreases along the length of the column.

3. The method of claim 1 wherein the step of altering a cross-sectional area of a column packed with media in the second chromatography system along a length of the column comprises using a column in the second chromatography system comprising an insert comprising a thickness that increases along the length of the column, wherein an outer surface of the insert is proximate to the inner surface of the column jacket and wherein media is packed within an inner surface of the insert such that a cross-sectional area packed with media within the column jacket decreases along the length of the column.

4. The method of claim 1 wherein the step of altering a cross-sectional area of a column packed with media in the second chromatography system along a length of the column comprises using a column in the second chromatography system comprising an insert comprising an annular cone, wherein media is packed between an inner surface of the column jacket and an outer surface of the insert such that a cross-sectional area within the column jacket comprising packed media decreases along the length of the column.

5. A column for a carbon dioxide based separation procedure in a chromatography system comprising:
a column jacket; and
media packed within the column jacket,
wherein a cross-sectional area of media packed within the column jacket decreases along the length of the column.

6. The column of claim 5 wherein the column jacket comprises a thickness that increases along the length of the column such that a cross-sectional area of media packed within the column jacket decreases along the length of the column.

7. The column of claim 5 further comprising an insert having a thickness that increases along the length of the column, wherein an outer surface of the insert is proximate to the inner surface of the column jacket and wherein media is packed within an inner surface of the insert such that a cross-sectional area packed with media within the column jacket decreases along the length of the column.

8. The column of claim 5 further comprising an insert comprising an annular cone, wherein media is packed between an inner surface of the column jacket and an outer surface of the insert such that a cross-sectional area within the column jacket comprising packed media decreases along the length of the column.

9. A method for efficiently transferring a carbon dioxide based separation procedure from a first chromatographic system to a second chromatographic system, the method comprising:
(a) identifying an average column pressure for the carbon dioxide based separation in the first chromatographic system;
(b) measuring a column pressure for the carbon dioxide based separation in the second chromatographic system; and
(c) comparing an average column pressure for the carbon dioxide based separation in the second chromatographic system with the identified average column pressure for the carbon dioxide based separation in the first chromatographic system; and
(d) adding makeup fluid along the length of a column in the second chromatography system to more closely match the identified average column pressure for the carbon dioxide based separation in the first chromatographic system.

10. The method of claim 9 wherein the step of adding makeup fluid along the length of the column in the second chromatography system comprises allowing makeup fluid to flow, from a channel of makeup fluid within the column in the second chromatography system, through a porous material and into packed media along the length of the column.

11. The method of claim 10 wherein the channel of makeup fluid is formed between an inner surface of the column jacket and an outer surface of a cylinder of porous material within the column.

12. The method of claim 10 wherein the channel of makeup fluid is formed within an inner surface of the cylinder of porous material within the column.

13. The method of claim 9 wherein the step of adding makeup fluid along the length of a column in the second chromatography system comprises allowing makeup fluid to flow, from a channel of makeup fluid within the column in the second chromatography system, through discrete apertures and into packed media along the length of the column.

14. The method of claim 13 wherein the channel of makeup fluid is formed between an inner surface of the column jacket and an outer surface of an annular cylinder comprising apertures within the column.

15. The method of claim 13 wherein the channel of makeup fluid is formed within an inner surface of an annular cylinder comprising apertures within the column.

16. A column for a carbon dioxide based separation procedure in a chromatography system comprising:
a column jacket; and
media packed within the column jacket,
an annular insert within the column jacket;
wherein the annular insert allows makeup fluid to flow from a channel of makeup fluid within the column jacket, through the annular insert, and into the packed media along the length of the column.

17. The column of claim 16 wherein a porosity of the annular insert allows makeup fluid to flow, from a channel of makeup fluid within the column jacket, through the annular insert and into the packed media along the length of the column.

18. The column of claim 16 wherein a plurality of discrete apertures allow makeup fluid to flow, from a channel of makeup fluid within the column in the second chromatography system, through the plurality of discrete apertures and into the packed media along the length of the column.

19. The column of claim 16 wherein the channel of makeup fluid is formed between an inner surface of the column jacket and an outer surface of the annular insert within the column.

20. The column of claim 16 wherein the channel of makeup fluid is formed within an inner surface of the annular insert within the column.
